(19) United States
(12) Patent Application Publication
(10) Pub. No.: US 2021/0173965 A1
(43) Pub. Date: Jun. 10, 2021

(54) HANGING TYPE SWITCHABLE ANTI-PEEPING DEVICE

(71) Applicants: Tzu-Lan Hsu, Taichung City (TW); Yu-Ting Pen, Taichung City (TW)

(72) Inventors: Tzu-Lan Hsu, Taichung City (TW); Yu-Ting Pen, Taichung City (TW)

(21) Appl. No.: 16/704,385

(22) Filed: Dec. 5, 2019

(51) Int. Cl. G06F 21/84; H04N 5/72

(52) U.S. Cl. CPC G06F 21/84; H04N 5/72

(57) ABSTRACT

A hanging type switchable anti-peeping device, removably hung on a displaying screen for an anti-peeping effect, includes two conductive layers, a displaying medium layer, and a drive unit. The displaying medium layer is between the conductive layers. The drive unit is electrically connected with the conductive layers. The drive unit provides a driving voltage between the conductive layers for driving the displaying medium layer to change the light permeability. At least one conductive layer has hollow portions arranged at intervals, forming a grille structure with a plurality of division portions. With the hollow portions arranged at intervals, during the lightening of the display screen, the transmittance of the hollow portions is higher than that of the division portions, improving the transmittance of the conductive layer. Thus, with the anti-peeping device hung on the displaying screen, the screen brightness would not decrease.

### BACKGROUND OF THE INVENTION

### 1. Field of the Invention

The present invention relates to hanging type switchable anti-peeping devices, and more particularly, to a hanging type switchable anti-peeping device externally applied on a screen for preventing others from peeping the screen.

### 2. Description of the Related Art

For achieving an anti-peeping effect for the displaying monitor of computers or mobile communication devices, an anti-peeping layer is added between the backlight module and the panel, whereby the angle of the visible range of the displaying monitor is narrowed down. For example, the visible range of certain displayers is narrowed down from 175 degrees to 45 degrees. However, the anti-peeping effect of the computers or mobile communication devices is not achievable without the anti-peeping layer.

Referring to FIG. 1, a conventional anti-peeping layer structure has a liquid crystal layer 2 formed between two conductive layers 1. When such anti-peeping layer structure is disposed between the backlight module and the display panel, the two conductive layers 1, by use of a driving voltage, achieve an anti-peeping effect upon the vision from a lateral viewpoint. However, the conductive layer 1 aforementioned is an integral plate member without bores thereon. During the practical usage, the light emitted by the backlight module is greatly weakened when passing through the conductive layer 1. As a result, although such device achieves the anti-peeping effect upon the vision from the lateral viewpoint, the brightness of the screen is greatly reduced, such that the user is prevented from clear vision when watching the screen because of the insufficient brightness. The resolution upon such issue is desirable for the present invention.

### SUMMARY OF THE INVENTION

For resolving the issues above, a hanging type switchable anti-peeping device is disclosed. With the anti-peeping device removably and externally hung on the displaying screen, an anti-peeping effect is provided on the displaying screen of a computer or mobile device which has no anti-peeping function. The anti-peeping device, when hung up, maintains the brightness of the screen for facilitating an optimal displaying effect.

For achieving the aforementioned objectives, in accordance with one embodiment of the present invention, a hanging type switchable anti-peeping device which is removably and externally hung on a displaying screen comprises two conductive layers, a displaying medium layer, and a drive unit. The displaying medium layer is disposed between the two conductive layers. At least one conductive layer comprises a plurality of hollow portions arranged at intervals to form a plurality of division portions in a grille structure. When the displaying screen lightens, the transmittance of the hollow portion is higher than the transmittance of the division portion. The drive unit is electrically connected with the two conductive layers and switchable between an ON status and an OFF status. In the ON status, the drive unit provides a driving voltage between the two conductive layers, thereby driving the displaying medium layer to change the light permeability thereof.

With such configuration, when the displaying screen lightens, based on the fact that the hollow portions of the conductive layer have a higher transmittance than the division portions, by driving the displaying medium layer between the two conductive layers to change the light permeability thereof during the ON status of the drive unit, an anti-peeping effect is achieved. Also, by use of the hollow portions of the conductive layer, the light of the displaying screen effectively passes through the conductive layer, providing an optimal transmittance of the conductive layer. Therefore, while achieving the aforementioned anti-peeping effect, an optimal displaying brightness of the displaying screen is maintained, so as to prevent the brightness reduction of the screen due to the anti-peeping device, thereby assuring the anti-peeping effect and the preferable brightness of displaying.

### BRIEF DESCRIPTION OF THE DRAWINGS

FIG. 1 is a schematic view of a conventional anti-peeping layer structure.

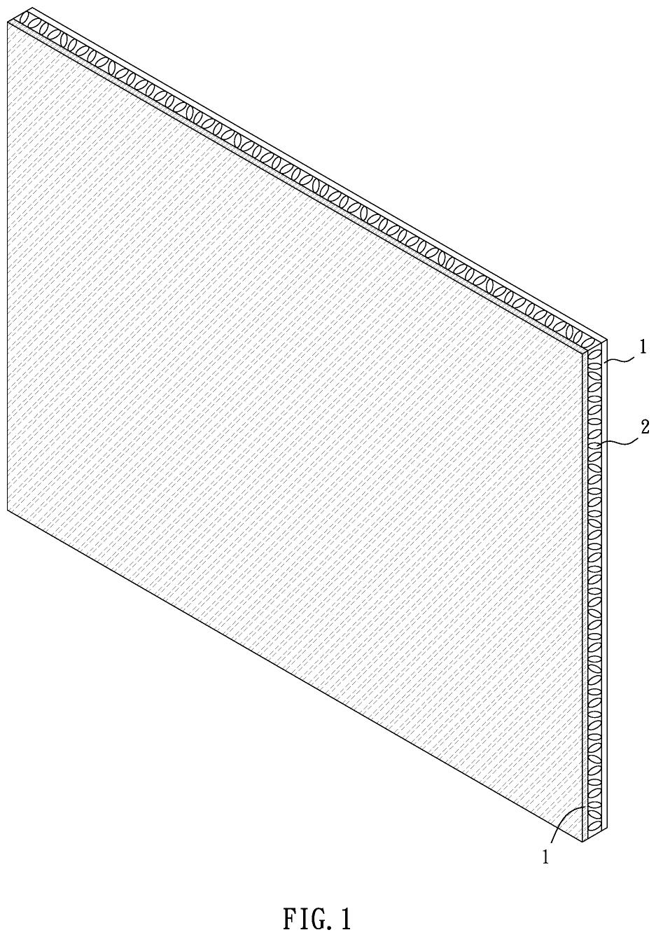

FIG. 2 is a schematic view illustrating the anti-peeping device hung on the displaying screen.

FIG. 3 is a schematic view illustrating the structure of the anti-peeping device in accordance with an embodiment of the present invention.

FIG. 4 is a schematic view illustrating the displaying medium layer disposed between the two conductive layers in accordance with the first embodiment of the present invention, wherein the hollow portions longitudinally pass through the first conductive layer and are arranged along a transverse orientation at intervals to form a stripe shape arrangement.

FIG. 5 is a schematic view illustrating the displaying medium layer disposed between the two conductive layers in accordance with the second embodiment of the present invention, wherein the hollow portions transversely pass through the first conductive layer and are arranged along a longitudinal orientation at intervals to form a stripe shape arrangement.

FIG. 6 is a schematic view illustrating the displaying medium layer disposed between the two conductive layers in accordance with the third embodiment of the present invention, wherein the hollow portions of the first conductive layer are arranged along both transverse and longitudinal orientations to form an array arrangement.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

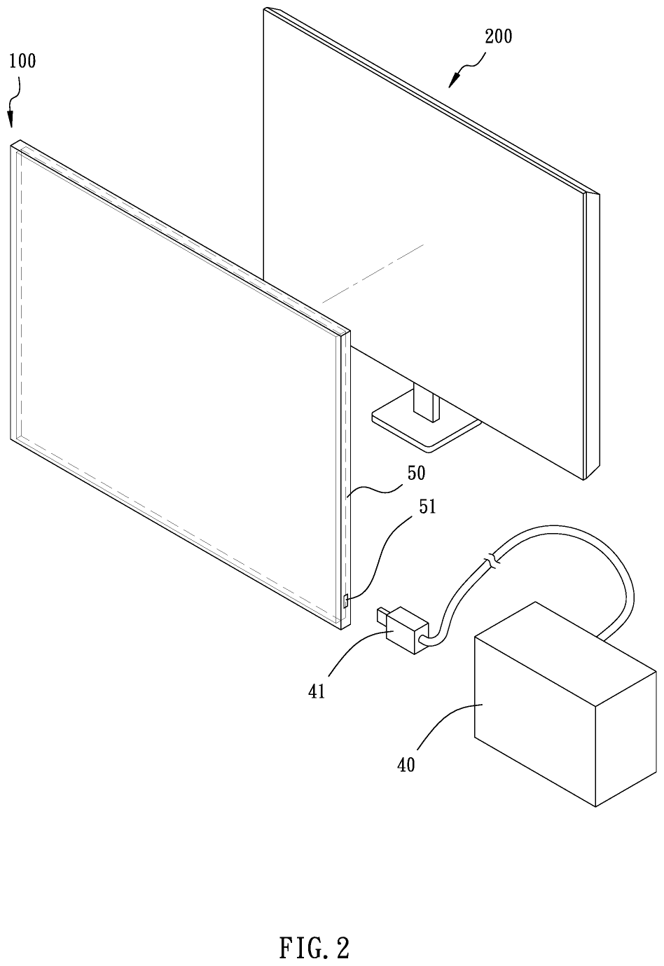

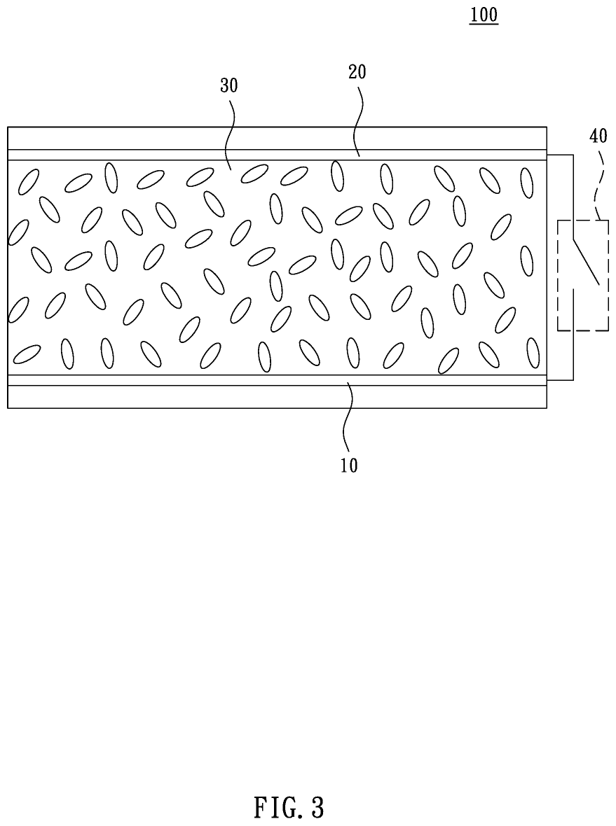

Referring to FIG. 2 to FIG. 6, a hanging type switchable anti-peeping device is provided, which is externally and removably hung on a displaying screen of a, for example, personal computer, laptop, or mobile communication device (smartphone or tablet computer) for providing an anti-peeping effect. As shown by FIG. 2, an anti-peeping device 100 in the embodiment is hung on a displaying screen 200 of a personal computer. The anti-peeping device 100 comprises two conductive layers including a first conductive layer 10 and a second conductive layer 20. Also, the anti-peeping device 100 comprises a displaying medium layer 30 and a drive unit 40.

The first conductive layer 10, in the embodiment, comprises a plurality of hollow portions 11 arranged at intervals. The hollow portions 11 form a plurality of division portions 12 therebetween, so that the division portions 12 and the hollow portions 11 of the first conductive layer 10 are alternately disposed to form a grille arrangement structure. When the displaying screen 200 lightens, the transmittance of the hollow portions 11 is higher than the transmittance of the division portions 12. The second conductive layer 20, in the embodiment, is an integral plate member without hollow portions 11. The second conductive layer 20 and the first conductive layers 10 in the embodiments are formed of glass material. In other embodiments, the second conductive layer 20 and the first conductive layers 10 are allowed to be a film. Also, the hollow portions 11 and the division portions 12 are alternately arranged at equal intervals.

The displaying medium layer 30 is disposed between the first conductive layer 10 and the second conductive layer 20. The displaying medium layer 30 is allowed to be, for example, liquid crystal (LC), polymer dispersed liquid crystal (PDLC), electrophoretic ink, or magnetic material. Therein, when a driving voltage is provided, the liquid crystal is capable of varying the direction of light beam, so as to vary the light permeability for achieving the anti-peeping effect.

The drive unit 40 is electrically connected with the first conductive layer 10 and the second conductive layer 20, thereby forming a power supply circuit therebetween. The drive unit 40 is switchable between an ON status and an OFF status. The ON status is defined as an electrified status that the drive unit 40 provides a driving voltage, and the OFF status is defined as a disconnection status that the drive unit 40 does not provide the driving voltage. When the drive unit 40 is in the ON status, the drive unit 40 provides the driving voltage between the first conductive layer 10 and the second conductive layer 20, such that the driving voltage drives the displaying medium layer 30 to change the light permeability thereof. The drive unit 40, in the embodiment, comprises an USB plug 41, and the anti-peeping device 100 in the embodiment comprises a main body 50 wrapping the first conductive layer 10, the second conductive layer 20, and the displaying medium layer 30, wherein the main body 50 comprises an USB socket 51 electrically connected with the first conductive layer 10 and the second conductive layer 20. When the USB plug 41 is inserted in the USB socket 51, the drive unit 40 is electrically connected with the first conductive layer 10 and the second conductive layer 20.

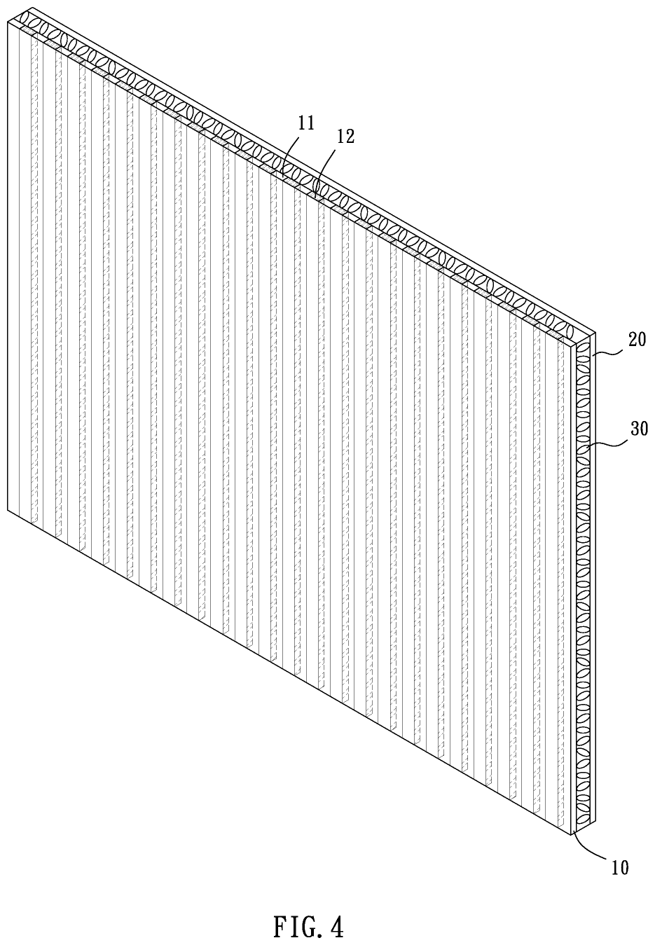

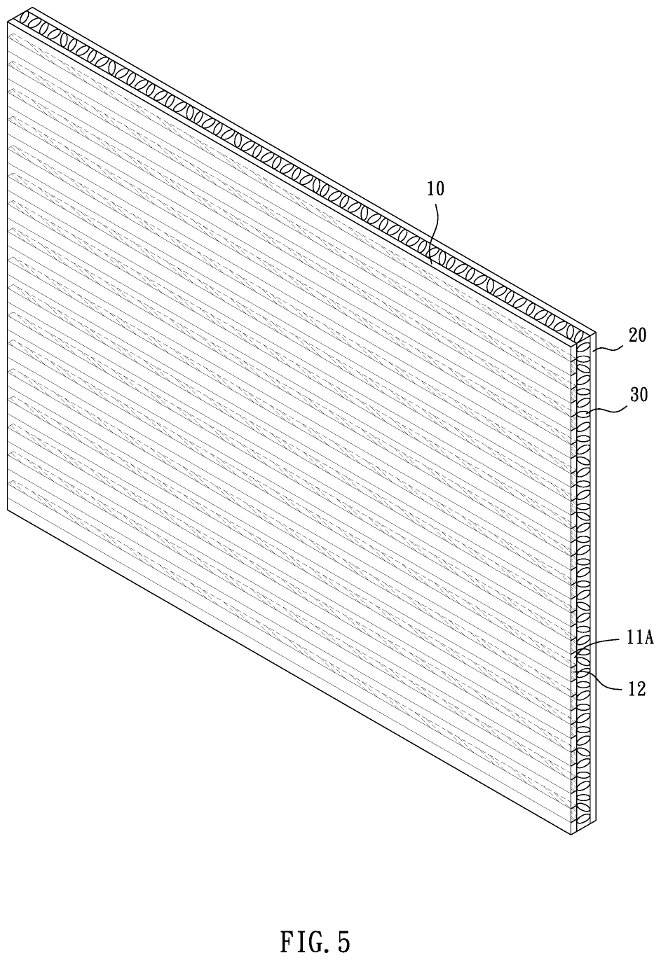

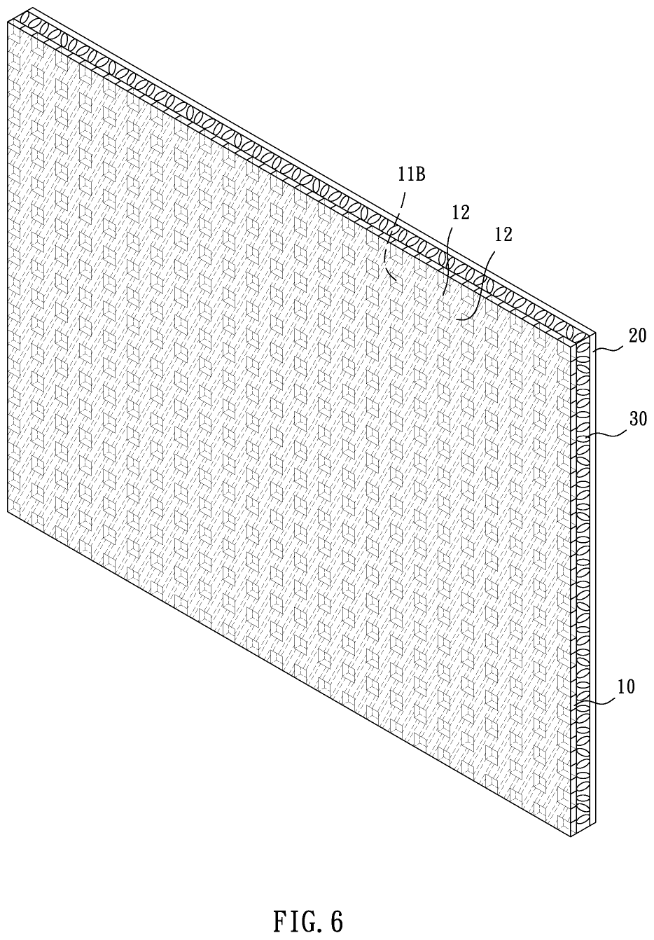

Particularly, the first conductive layer 10 is applied in various embodiments. Referring to FIG. 4, a first embodiment of the present invention is illustrated. Therein, the plurality of hollow portions 11 of the first conductive layer 10 longitudinally pass through the first conductive layer 10 and are transversely arranged at intervals, so as to provide the anti-peeping effect upon the visions from the left side and right side. Referring to FIG. 5, a second embodiment of the present invention is illustrated. Therein, the hollow portions 11A of the first conductive layer 10 transversely pass through the first conductive layer 10 and are longitudinally arranged at intervals, so as to provide the anti-peeping effect upon the visions from the upper side and lower side. Referring to FIG. 6, a third embodiment of the present invention is illustrated, the plurality of hollow portions 11B of the first conductive layer 10 are disposed along a transverse and longitudinal orientations, forming an array shaped arrangement, so as to provide the anti-peeping effect upon the visions from the upper side, lower side, left side, and right side. Notably, the aforementioned “longitudinal” and “transverse” are defined according to the actual direction along which the anti-peeping device 100 is hung on the displaying screen 200.

The first conductive layer 10 includes various forms as mentioned in the first, second, and third embodiments. Further, when the first conductive layer 10 is provided in any form of the three embodiments, the second conductive layer 20 is allowed to be embodied as a plate member without the hollow portions 11, 11A, or 11B. The second conductive layer 20 is also allowed to be optionally provided in any form of the three embodiments as the first conductive layer 10. Upon the second conductive layer 20 being embodied in any form of the three embodiments, the first conductive layer 10 is allowed to be embodied as a plate member without the hollow portions 11, 11A, or 11B. In other words, when the first conductive layer 10 is provided in any form of the three embodiments, the second conductive layer 20 is also allowed to be embodied in the form of the first, second, or third embodiments of the first conductive layer 10 or as a plate member without the hollow portions 11, 11A, or 11B; when the second conductive layer 20 is provided in any form of the three embodiments, the first conductive layer 10 is also allowed to be embodied in the form of the first, second, or third embodiment, or as a plate member without the hollow portions 11, 11A, or 11B. During the driving voltage being provided as aforementioned, the first conductive layer 10 and the second conductive layer 20 provide the anti-peeping effect upon the visions from different viewpoints in accordance with the first, the second and the third embodiment, so as to fulfill the actual usage demand.

With the foregoing configuration, when the displaying screen 200 lightens in the displaying status, the drive unit 40 is able to be switched to the ON status, so as to drive the displaying medium layer 30 between the first conductive layer 10 and the second conductive layer 20 to change the light permeability of the displaying medium layer 30. For example, when the driving voltage is provided, the liquid crystal changes the direction of light beam therein to change the light permeability thereof. Based on the fact that the transmittance of the hollow portions 11, 11A, and 11B of the first conductive layer 10 (or the second conductive layer 20 in other embodiments) is higher than the transmittance of the division portions 12, the anti-peeping effect is provided upon the visions from the viewpoints on the left, right, upper, or lower side. Besides, the light beam of the displaying screen 200 is allowed to effectively pass through the hollow portions 11, 11A, and 11B of the first conductive layer 10. The present invention facilitates an optimal transmittance of the conductive layers (including the first conductive layer 10 and the second conductive layer 20), so as to maintain the displaying brightness of the displaying screen 200 while providing the anti-peeping effect simultaneously, preventing the brightness of the displaying screen 200 from decrease due to the anti-peeping device 100, thereby achieving both the anti-peeping and optimal brightness maintaining functions.

Furthermore, regarding the anti-peeping device 100 in the aforementioned embodiments, the twofold functions are provided with only one set of stacked layers which has the displaying medium layer 30 disposed between the two conductively layers 10, 20. In other embodiments, the layer structure is allowed to be carried out by at least two sets of stacked layers, which provides a superior anti-peeping effect compared with the aforementioned embodiments having only one set of stacked layers.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An hanging type switchable anti-peeping device, which is externally and removably hung on a displaying screen to provide an anti-peeping effect, comprising:
two conductive layers, at least one of the two conductive layers comprising a plurality of hollow portions disposed at intervals, the hollow portions forming a plurality of division portions disposed at intervals, the hollow portions and the division portions forming a grill structure; when the displaying screen lightens, a transmittance of the hollow portions is higher than a transmittance of the division portions;
a displaying medium layer disposed between the two conductive layers; and
a drive unit electrically connected with the two conductive layers and switchable between an ON status and an OFF status, the drive unit providing a driving voltage between the two conductive layers in the ON status, so as to drive the displaying medium layer to change a light permeability of the displaying medium layer.

2. The anti-peeping device of claim 1, wherein when the anti-peeping device is hung on the displaying screen, the hollow portions longitudinally pass through the conductive layer in which the hollow portions are disposed, and the hollow portions are arranged along a transverse orientation at intervals to form a stripe shaped arrangement.

3. The anti-peeping device of claim 1, wherein when the anti-peeping device is hung on the displaying screen, the hollow portions transversely pass through the conductive layer in which the hollow portions are disposed, and the hollow portions are arranged along a longitudinal orientation at intervals to form a stripe shaped arrangement.

4. The anti-peeping device of claim 1, wherein the hollow portions are disposed in an array arrangement on the conductive layer in which the hollow portions are disposed, and transversely and longitudinally pass through the conductive layer in which the hollow portions are disposed.

5. The anti-peeping device of claim 1, wherein the conductive layers are formed of a material selected from a group consisting of a glass and a film.

6. The anti-peeping device of claim 1, wherein one of the two conductive layers is formed in a grille structure, and the other conductive layer is a plate member without the hollow portions.

7. The anti-peeping device of claim 1, wherein the two conductive layers are formed in a grille structure.

8. The anti-peeping device of claim 1, wherein the hollow portions are arranged at equal intervals on the conductive layer in which the hollow portions are disposed.

9. The anti-peeping device of claim 1, wherein the displaying medium layer is formed in a material selected from a group consisting of liquid crystal, polymer dispersed liquid crystal, electrophoretic ink, and magnetic material.
